(19) United States
(12) Patent Application Publication
(10) Pub. No.: US 2009/0228218 A1
(43) Pub. Date: Sep. 10, 2009

(54) Composite Inspection Tool Suite

(75) Inventor: Mark Butkiewicz, Belcamp, MD (US)

Correspondence Address: PROCOPIO, CORY, HARGREAVES & SAVITCH LLP, 530 B STREET, SUITE 2100, SAN DIEGO, CA, 92101, US

(73) Assignee: SURVICE ENGINEERING COMPANY, Belcamp, MD (US)

(21) Appl. No.: 12/400,608

(22) Filed: Mar. 9, 2009

Related U.S. Application Data
(60) Provisional application No. 61/034,580, filed on Mar. 7, 2008.

(51) Int. Cl. G01N 29/04; G01B 11/30

(52) U.S. Cl. 702/39; 702/40

(57) ABSTRACT

Described herein are systems and methods that provide the ability for ultrasonic inspection to be performed on both traditional and composite materials in the field to automatically identify defects with minimal error.

### RELATED APPLICATION

The present application claims priority to U.S. provisional patent application Ser. No. 61/034,580 filed Mar. 7, 2008, which is incorporated herein by reference in its entirety.

### BACKGROUND

1. Field of the Invention

The present invention generally relates to composite material inspection and more particularly relates to a portable system for accurate and automatic composite material inspection including scanning of non-visible damage.

2. Related Art

Conventional ultrasonic equipment allows material defects to be determined through expert knowledge and understanding of feedback. These conventional systems are essentially an electronic method of performing “coin tap” testing, which also requires expert knowledge and/or experience to locate defects in composite materials. One significant problem with the conventional systems for composite material inspection is that on composite structures (e.g., aircraft), material thicknesses (and potentially construction layup) constantly vary which further complicates the automation of ultrasonic inspection and defect identification. Additionally, stringers and other internal support members further complicate ultrasonic inspection and defect identification in composite materials. Therefore, what is needed is a system and method that overcomes these significant problems found in the conventional systems as described above.

### SUMMARY

Accordingly, described herein are systems and methods that integrate laser metrology hardware, ultrasonic sensing equipment, and laser projection systems to accurately collect ultrasonic scans of suspect structural elements at specific locations in three-dimensional space and compare these scans to previous scans at identical locations previously taken on undamaged/virgin structural elements. The ability to take measurements at the same location in the field as those taken at the factory eliminates uncertainties and errors associated with post-processing ultrasonic scan data since the same material composition and thicknesses are assured. Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1A is a cross sectional diagram of an example composite panel having a varying thickness as a function of location according to an embodiment of the present invention;

FIG. 1B is a graph diagram illustrating an example comparison of a first ultrasonic signature produced by an ultrasonic scan of a composite panel at a specific location and a second ultrasonic signature produced by an ultrasonic scan of a composite panel at the same location according to an embodiment of the present invention;

FIG. 2A is a side view of an example metrology vector bar including an integrated ultrasonic sensor for measuring three dimensional locations via a contact touch probe according to an embodiment of the present invention;

FIG. 2B is an exploded view of the example metrology vector bar shown in FIG. 2A according to an embodiment of the present invention;

FIG. 2C is a detailed view of an example flush coupling used in the metrology vector bar shown in FIG. 2A according to an embodiment of the present invention;

FIG. 2D is a detailed view of an example metrology vector bar having a grasping mechanism and an indicator light according to an embodiment of the present invention;

FIG. 2E is a plan view of the example metrology vector bar shown in FIG. 2D according to an embodiment of the present invention;

FIG. 3 is a flow diagram illustrating an example process for detecting material errors in the field according to an embodiment of the present invention;

FIG. 4 is a block diagram illustrating an example metrology system for detecting material errors in the field according to an embodiment of the present invention; and

FIG. 5 is a block diagram illustrating an example computer system that may be used in connection with various embodiments described herein.

### DETAILED DESCRIPTION

Certain embodiments as disclosed herein provide for automated detection of defects in structures and the assessment of delamination within composite structures for rapid, in-field damage assessment and repair. For example, one method as disclosed herein allows for in-field ultrasonic measurements to be taken at a particular location on a composite material structure and compared to a prior ultrasonic measurement taken at the same location on the same composite material structure. The ultrasonic measurements are then compared and analyzed to determine the extent of possible composite delamination or other defects.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

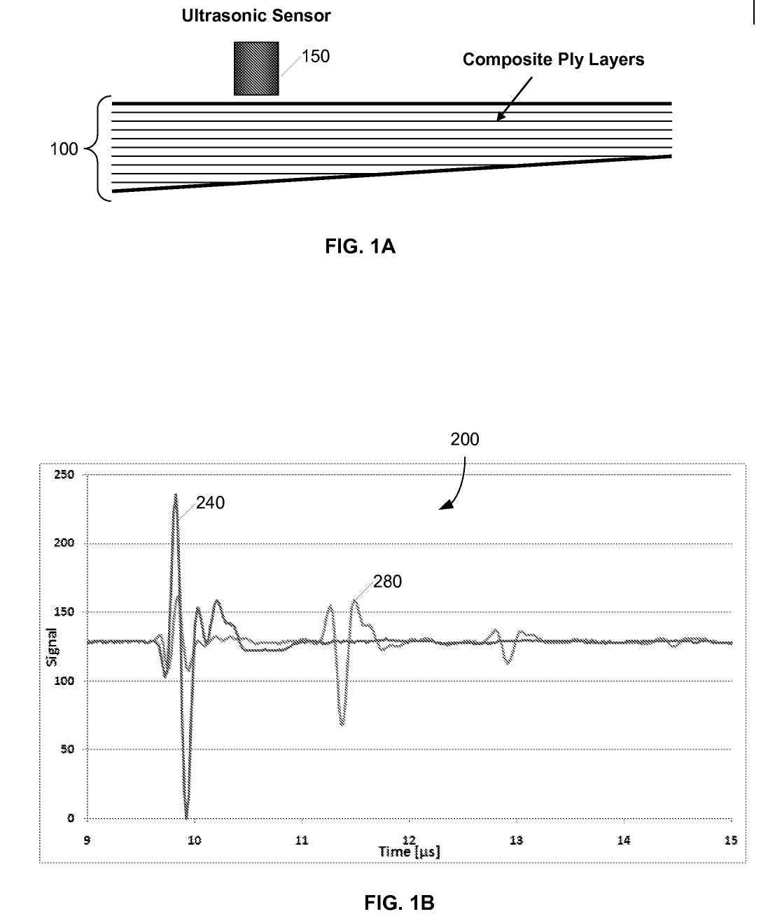

FIG. 1A is a cross sectional diagram of an example composite panel 100 having a varying thickness as a function of location according to an embodiment of the present invention. For example, the composite panel 100 could be used in an aircraft. The panel 100 has a plurality of composite ply layers that result in the panel 100 having a varying thickness, which is also typical for composite materials. Accordingly, when the ultrasonic sensor 150 performs an ultrasonic scan of the composite panel 100, the sensor 150 produces a unique ultrasonic signature at virtually every location on the panel 100 due to the varying thickness. Stringers and other support members within the composite panel 100 also add to the uniqueness of the ultrasonic signature.

FIG. 1B is a graph diagram illustrating an example comparison 200 of a first ultrasonic signature 240 produced by an ultrasonic scan of a composite panel at a specific location and a second ultrasonic signature 280 produced by a later ultrasonic scan of a composite panel at the same location according to an embodiment of the present invention. Thus, when a baseline signature 240 at a specific location of a panel that is defect free is compared to a later signature 280 of the same location, the ultrasonic signature traces allow defects to be accurately and automatically identified. A computer system connected to a portable scanner can perform an initial comparison and flag those locations where the comparison indicates a possible defect. The first and later scans may be of the same physical composite panel or they may be of different physical composite panels.

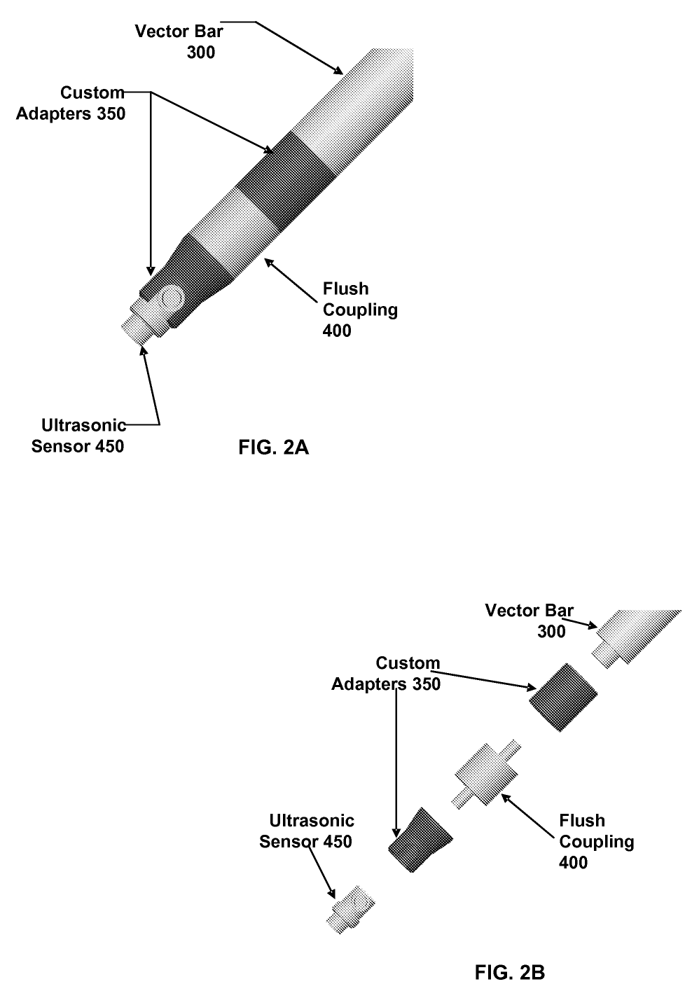

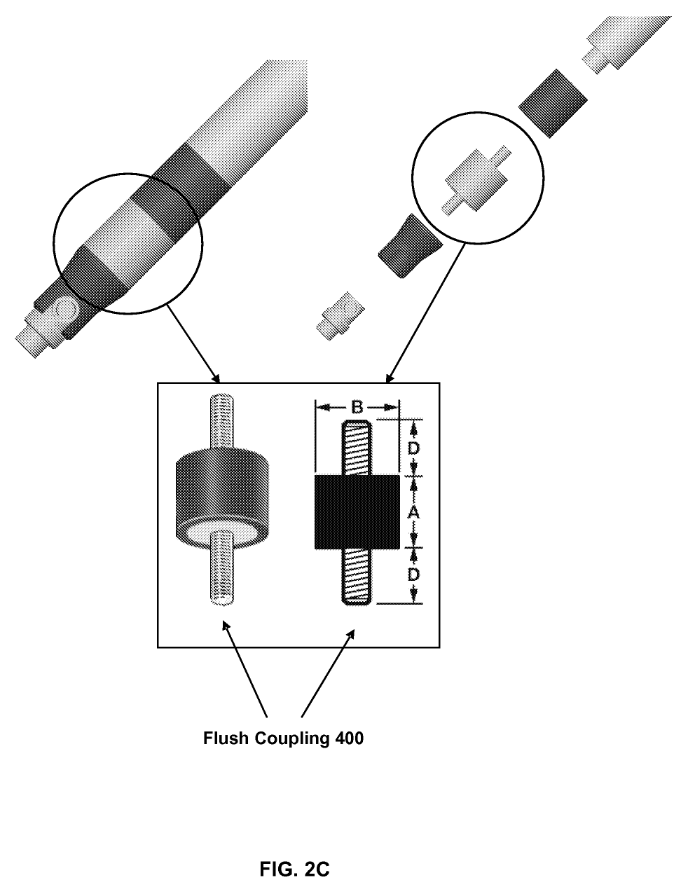

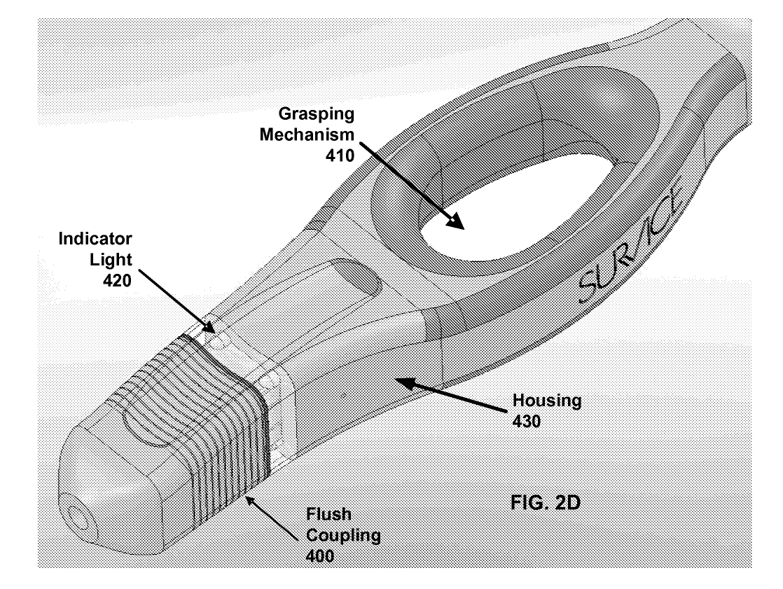

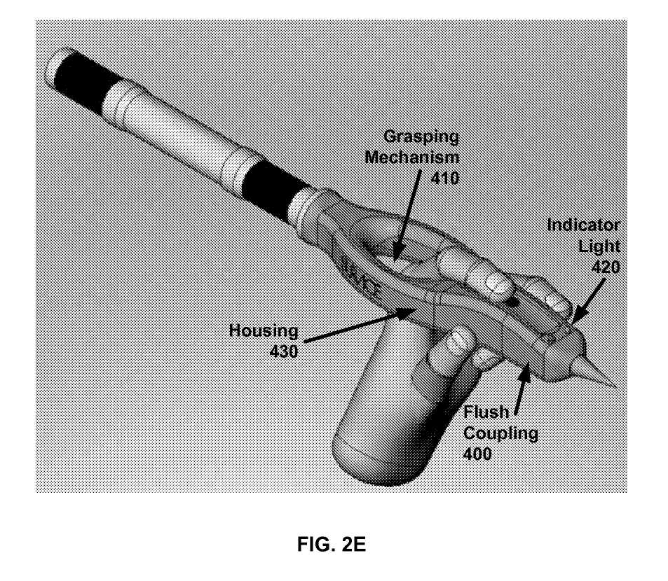

FIG. 2A is a side view of an example metrology vector bar 300 including an integrated ultrasonic sensor 450 for measuring three dimensional locations via a contact touch probe according to an embodiment of the present invention. Advantageously, the vector bar 300 can determine the specific location of the tip of the vector bar 300, where the ultrasonic sensor 450 is placed. Accordingly, initial scans of known defect free structures taken by the ultrasonic sensor 450 can be precisely located in three dimensional space with reference to the scanned structure. The vector bar 300 can later reposition the ultrasonic sensor in the same three dimensional location with respect to the structure (the same or a copy) so that a subsequent scan can be reliably taken at the same location. Thus, new defects can be identified as a result of a comparison analysis of the initial and subsequent scans that were taken at the same location.

FIG. 2B is an exploded view of the example metrology vector bar 300 shown in FIG. 2A according to an embodiment of the present invention. Also shown in FIGS. 2A and 2B are the custom adaptors 350 and flush coupling 400 that facilitate connection of the ultrasonic sensor 450 at the tip of the vector bar. The flush coupling 400 allows minor flexure of the ultrasonic sensor 450 to maintain flush contact with the surface of panel 100 during scanning even if the metrology vector bar 300 is not perfectly perpendicular with the surface of panel 100. FIG. 2C is a detailed view of an example flush coupling 400 used in the metrology vector bar shown in FIGS. 2A and 2B.

As illustrated in FIGS. 1A-2C, integrating one or more ultrasonic sensors with metrology equipment allows for the collection of ultrasonic measurements at precise three-dimensional spatial locations. The key is to be able to compare this data to an ultrasonic measurement taken at the same location on a material sample that is known to be defect free. For example, the defect free measurement can be taken in a laboratory or factory environment or prior to deployment of the material that was measured.

In one embodiment, a laser projection system is used that is operatively associated with the metrology equipment for precise location and mapping purposes. The laser projection system projects a grid onto a given panel and ultrasonic measurements are taken at each grid point and stored in a database for later use. For example, the grid is projected over a defect free panel in a laboratory/factory environment to generate the baseline signature/measurement.

Later, when a panel is being evaluated for damage in the field, a portable laser projection system is used in connection with the metrology equipment to project the same grid on the panel such that the grid points are in the same location as the prior scan in the laboratory/factory environment. An operator, using the modified vector bar with ultrasonic sensor equipment integrated into the vector bar, collects ultrasonic measurements at the same locations as those collected in the laboratory/factory. A portable computer can then access the prior measurement data from a local or remote database and direct comparisons can then be automatically made by a the computer (since the measurement data was taken at the same locations). Locations with significant differences identified by the comparison can then be flagged as areas likely having panel defects. The portable computer may also send the new measurement data to a remote location for comparison with the prior measurement data, for example by a comparison server computer or the like. This can be done, for example through a wired or wireless communication network or a portable data storage medium.

FIG. 2D is a detailed view of an example metrology vector bar having a grasping mechanism 410 and an indicator light 420 according to an embodiment of the present invention. The metrology vector bar also has housing 430 and a flush coupling 400 disposed within the housing. The flush coupling 400 includes a plurality of slits cut into the material of the flush coupling 400. The slits reduce the rigidity of the material enough to provide flexure of the flush coupling 400 in order to allow the sensor on the metrology vector bar to maintain contact with the material being interrogated.

Various alternative embodiments of the flush coupling 400 may be employed. The flush coupling 400 may be made of a flexible material such as rubber or the material may be designed such that it provides flexure. For example, a hard plastic material that includes a series of slits that reduce the rigidity enough to provide flex but not compromise the integrity of the coupling function. In an alternative embodiment, the flush coupling may include a tension mechanism (e.g., a spring or piston) that extends the sensor such that pressure from the operator opposing the pressure exerted by the tension mechanism cooperate to keep the sensor in contact with the material being interrogated. Advantageously, the function of the flush coupling 400 is to allow the sensor to maintain flush contact with the material being interrogated.

In the illustrated embodiment, the metrology vector bar also includes a grasping mechanism 410 and one or more indicator lights 420. The grasping mechanism is shown as a cavity defined by the metrology vector bar and the cavity is preferably large enough to allow one or more fingers of an operator to pass through the cavity and thereby securely grip the metrology vector bar. The indicator light 420 is operably connected to the sensor and extends through the housing and advantageously provides visual feedback from the metrology vector bar and sensor. For example, the indicator light can be configured to illuminate (or illuminate in a particular color) when the sensor is in flush contact with the material being interrogated. The indicator light 420 may also illuminate (or illuminate in a particular color) to indicate the current function. For example, the current function may include interrogating the material or locating a reference point of the laser grid.

FIG. 2E is a plan view of the example metrology vector bar shown in FIG. 2D according to an embodiment of the present invention. In the illustrated embodiment, the metrology vector bar includes a flush coupling 400, a grasping mechanism 410, and an indicator light 420. A housing 430 encases the end of the metrology vector bar. As shown, an operator is holding the metrology vector bar using the grasping mechanism 410. The flush coupling 410 is disposed inside the housing 430 and connected to the sensor (not shown). One or more indicator lights 420 extend through the housing 430 to provide visual feedback to the operator. The visual feedback may relay information to the operator about the current function of the metrology vector bar and/or sensor or it may provide feedback to the operator regarding the operation of the sensor, e.g., the indicator light may be illuminated (or illuminated in a particular color) when the sensor is in flush contact with the material being interrogated.

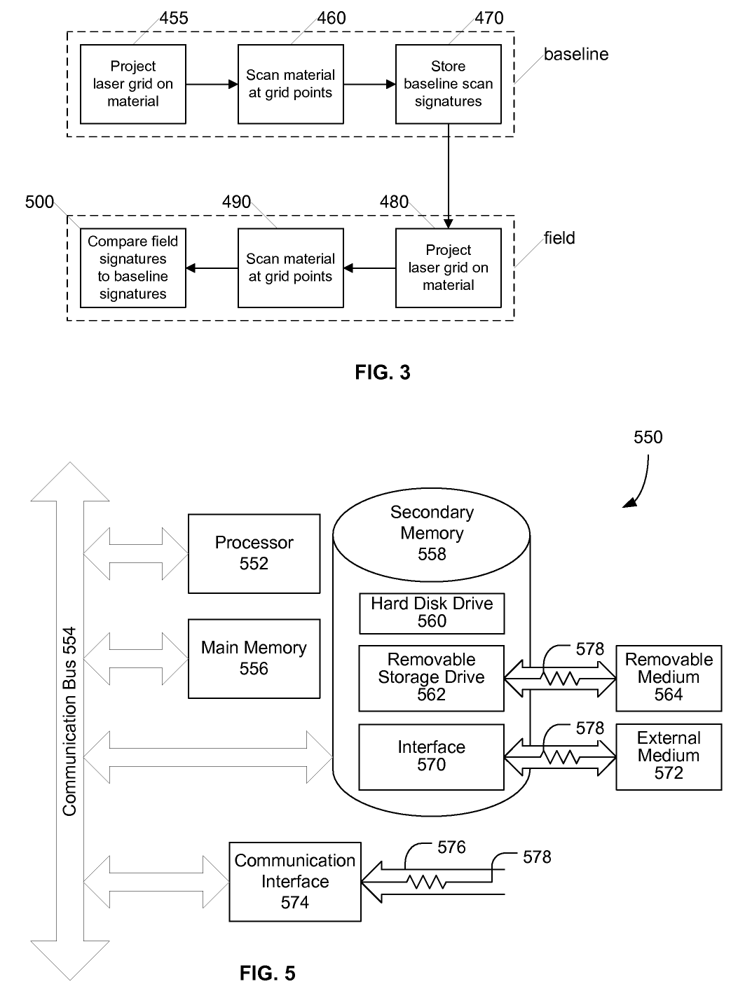

FIG. 3 is a flow diagram illustrating an example process for detecting material errors in the field according to an embodiment of the present invention. The process contemplates an initial scanning and storing of a baseline signature for the material (e.g., a composite material) and then later scanning the signature of the material in the field. It will be understood that the baseline signature may be scanned and stored with respect to a reference material and that the material scanned in the field may be the exact same reference material or a copy thereof. Thus, for mass produced parts, a single baseline signature can be stored and compared to any one of the mass produced parts in the field.

Initially, in step 455 the laser projection system projects a grid onto the material. The laser grid advantageously provides reference points at which the material can be scanned. Next, in step 460 the material is scanned at one or more of the reference points (e.g., points on the projected grid) and then a signature is stored for each reference point. Additionally, a composite signature of a plurality of points may also be stored.

Out in the field, when the material (or copy thereof) is suspected of damage or it is otherwise desirable to confirm its integrity, a portable laser projection system can be used to project a laser grid onto the material as shown in step 480 to provide the same reference points on the material. Next, in step 490, the material is then scanned at one or more of the reference points and the resulting signatures are stored in memory (volatile or persistent) and then in step 500 the field signatures are compared to the baseline signatures for each reference point. If a composite signature was previously calculated and stored, a field composite signature can be calculated in the field and compared to the stored composite signature.

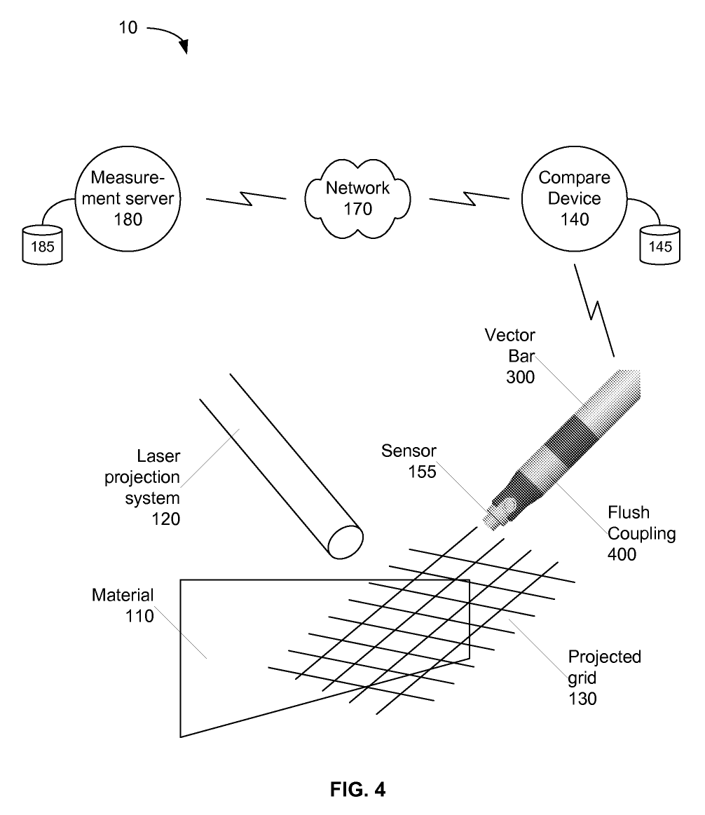

FIG. 4 is a block diagram illustrating an example metrology system 10 for detecting material errors in the field according to an embodiment of the present invention. In the illustrated embodiment, the system 10 comprises a laser projection system 120 that is configured to project a grid 130 onto the material 110 in the field. The system 10 further includes a vector bar 300 that has a sensor 155 that can be used to interrogate the material 110. The sensor 155, for example, can be an ultrasonic sensor. The vector bar is operatively coupled with the laser projection system so that the vector bar can be precisely locate such that its measurements of the material 110 can be take from specific locations that were predetermined when the material (or it's equivalent) was previously measured in a baseline setting.

Additionally, the system 10 includes a compare device 140 that is communicatively coupled with the vector bar 300 and/or laser projection system 120. The compare device 140 can be implemented on a computer system such as later described with respect to FIG. 5. The compare device has a local data storage area for storing baseline signatures and field signatures as well as operative programs that enable performing the comparisons and also enable communications with the vector bar 300 and laser projection system 120 (e.g., to control these devices and systems). The compare device 140 is also communicatively coupled with a measurement server 180 via a network 170.

The measurement server may be implemented on a computer system such as later described with respect to FIG. 5 and serves to store and provide baseline signatures to the compare device 140. The baseline signatures can be stored in the data storage area 185 that is accessible to the measurement server 180. In one embodiment, the measurement server may also perform the comparisons of the baseline signatures and field signatures.

The network 170 may be any sort of wired or wireless network or any combination of the two and the network 170 may also be either a public or private network or any combination of the two. In one embodiment, the network 170 may include the Internet.

FIG. 5 is a block diagram illustrating an example computer system 550 that may be used in connection with various embodiments described herein. For example, the computer system 550 may be used in conjunction with a portable computer or comparison server computer, as part of the laser projection system, metrology bar system, ultrasonic scanner system, or other computer controlled or implemented devices. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A vector bar for determining the precise location of the tip of the vector bar, comprising:
a vector bar having a proximal end and a distal end;
an first adapter connected to the proximal end of the vector bar;
a flush coupling connected to the first adapter, the flush coupling configured to allow flexure of the vector bar;
a second adapter connected to the flush coupling;
a sensor connected to the second adapter bar, the sensor configured to interrogate a material to provide information for determining a signature of the material.

2. A computer implemented method for detecting defects in a suspect material, comprising:
projecting a first grid onto a surface of a defect free material, said first grid having a first set of reference points wherein each reference point in the first set of reference points has a three dimensional location;
interrogating the defect free material at each reference point in the first set of reference points;
determining a first signature for the defect free material at each reference point and storing said signatures in a data storage area;
projecting a second grid onto a surface of a suspect material, said second grid having a second set of reference points wherein each reference point in the second set of references points has a three dimensional location substantially identical to a first reference point in the first set of reference points;
interrogating the suspect material at each reference point in the second set of reference points; and
determining a second signature for the suspect material at each reference point and storing said signatures in a data storage area; and
comparing each of the first signatures with its corresponding second signature to identify a defect in the suspect material.

3. A metrology system, comprising:
a laser projection system configured to project a grid onto a surface of a material, said grid having a set of reference points wherein each reference point has a three dimensional location substantially identical to a predetermined reference point;
a vector bar comprising a flush coupling configured to allow flexure of the vector bar and a sensor disposed at an end of the vector bar;
a compare device communicatively coupled to the vector bar, the compare device configured to receive data from the sensor for a predetermined reference point, determine a signature for the predetermined reference point, and compare the signature to a signature of a known defect free material at the predetermined reference point.

4. The metrology system of claim 3, further comprising a measurement server communicatively coupled with the compare device via a data network, the measurement server configured to store and signatures of known defect free material and provide said signatures to the compare device upon request.
